(19) United States
(12) Patent Application Publication
(10) Pub. No.: US 2009/0113128 A1
(43) Pub. Date: Apr. 30, 2009

(54) METHOD AND SYSTEM FOR PREVENTING VIRUS INFECTIONS VIA THE USE OF A REMOVABLE STORAGE DEVICE

(75) Inventor: Shi-Ming Zhao, Taipei City (TW)

Correspondence Address: GENE I. SU, XIN YI RD., SECTION 4, NO. 151, 17F-1, TAIPEI, TW

(73) Assignee: SUMWINTEK CORP., Hsinchu County (TW)

(21) Appl. No.: 12/141,077

(22) Filed: Jun. 17, 2008

Related U.S. Application Data
(60) Provisional application No. 60/982,144, filed on Oct. 24, 2007.

(51) Int. Cl. G06F 12/00

(52) U.S. Cl. 711/115; 711/E12.001

(57) ABSTRACT

A method and system for preventing virus infections via the use of a removable storage device are described. Specifically, one embodiment of the present invention sets forth a method, which includes the steps of gathering a first set of information associated with the removable storage device, processing the first set of information to generate a second set of information also associated with the removable storage device, sending the second set of information to the computer to cause the computer to identify the removable storage device as a read-only device, accessing an antivirus program stored in the removable storage device and causing the antivirus program to be launched on the computer, and sending a third set of information to the computer after the antivirus program is launched on the computer to cause the computer to identify the removable storage device as a writable device.

### CROSS-REFERENCE TO RELATED APPLICATIONS

This application claims the benefit of the U.S. Provisional Application No. 60/982,144, filed on Oct. 24, 2007 and having Atty. Docket No. SWTK-0002-US-PRO. This related application is hereby incorporated by reference in its entirety.

### BACKGROUND OF THE INVENTION

1. Field of the Invention

Embodiments of the present invention relates generally to removable storage devices and more specifically to a system and method for preventing virus infections via the use of a removable storage device.

2. Description of the Related Art

Unless otherwise indicated herein, the approaches described in this section are not prior art to the claims in this application and are not admitted to be prior art by inclusion in this section.

Computer viruses, worms, Trojans, and spyware are examples of malicious code that threaten computer systems everywhere. Although there are distinct differences among these various types of malicious code, one class of the malicious code, computer viruses, is primarily discussed herein. Likewise, one type of program designed to combat malicious code, an “antivirus program” is mainly discussed herein.

In recent years, removable storage devices have become ubiquitous. For example, Universal Serial Bus (USB) storage devices, also known as USB sticks, are widely used to store data from computers after connections between the USB sticks and the computers are established. If a computer with which a USB stick is attached to lacks adequate protection against viruses, the computer can be easily infected with viruses that the USB stick has already been infected with soon after the computer and the USB stick connect. Conversely, viruses that are resident on the computer can easily infect the USB stick once the USB stick connects with the computer. Then, this infected USB stick can further spread the viruses to other computers that the USB stick comes in contact with.

One conventional approach to address the aforementioned problems is to store an antivirus program on the USB stick. FIG. 1 is a flow chart illustrating the method steps performed by such a conventional USB stick containing an antivirus program. In response to the insertion of the USB stick into a USB port of a computer, a USB host controller managing the USB port generates a signal to cause the computer to identify the inserted USB stick in step 101. After the computer identifies the inserted USB stick, the computer loads the antivirus program stored on the USB stick to the main memory of the computer in step 103. The computer proceeds to execute the antivirus program in step 105 to scan data transferred between the computer and the USB stick for viruses.

While the aforementioned approach provides a straight forward method to guard the USB stick against virus infection during the data transferring process between the computer and the USB stick, the approach has various shortcomings. For example, before the computer has a chance to load and execute the antivirus program, the USB stick is still exposed to attacks by the potential viruses having already infected the computer as soon as the connection between the computer and the USB stick is established. In other words, viruses on the computer can still infect the USB stick before the antivirus program is launched. Similarly, before the antivirus program is executed, the computer is also at risk of being infected by the potential viruses having already infected the USB stick.

As the foregoing illustrates, what is needed is a method and system for preventing virus infections through the use of a removable storage device and addressing at least the problems set forth above.

### SUMMARY OF THE INVENTION

A method and system for preventing virus infections via the use of a removable storage device are described. Specifically, one embodiment of the present invention sets forth a method, which includes the steps of gathering a first set of information associated with the removable storage device, processing the first set of information to generate a second set of information also associated with the removable storage device, sending the second set of information to the computer to cause the computer to identify the removable storage device as a read-only device, accessing an antivirus program stored in the removable storage device and causing the antivirus program to be launched on the computer, and sending a third set of information to the computer after the antivirus program is launched on the computer to cause the computer to identify the removable storage device as a writable device.

At least one advantage of the present invention disclosed herein is the ability to make the removable storage device appear as a read-only device to a computer before the antivirus program is launched on the computer, so that the virus is less likely to infect the removable storage device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a flow chart illustrating the method steps performed by a conventional USB stick containing an antivirus program;

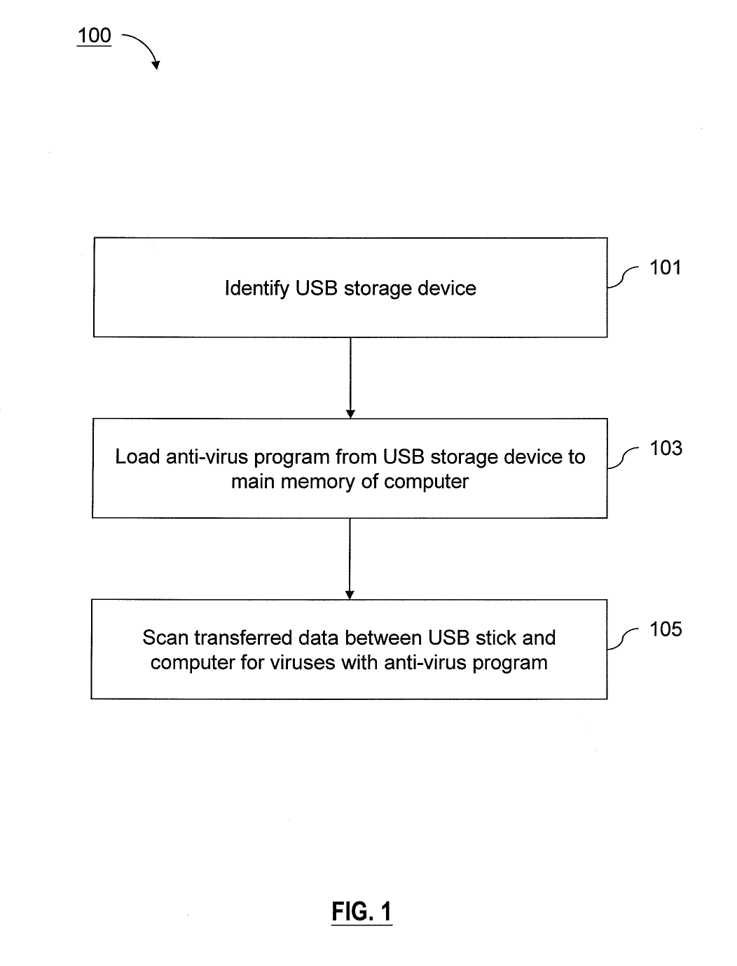

FIG. 2A is a flow chart illustrating the method steps of a USB stick configured to prevent virus infection as it comes into contact with a computer, according to one embodiment of the invention;

FIG. 2B is a flow chart illustrating the method steps of a USB stick configured to prevent virus infection as it comes into contact with a computer, according to another embodiment of the invention;

FIG. 3A is a conceptual diagram of a chip illustrating certain control signal flow and data signal flow that cause a computer connected to a USB stick to identify the USB stick as a read-only device, according to one embodiment of the invention;

FIG. 3B is another conceptual diagram of a chip illustrating certain control signal flow and data signal flow after the antivirus program is launched on the computer, according to one embodiment of the invention; and

FIG. 4 is a conceptual diagram of a USB stick configured to implement one or more aspects of the present invention.

### DETAILED DESCRIPTION

Throughout this disclosure, the term “removable storage device” broadly refers to a writable removable storage device, such as a removable hard-disk drive, a USB stick, or any removable device with any other types of random-access semiconductor memory capable of storing alterable information.

In accordance with an embodiment of the invention, a removable storage device includes a controller and a storage area. The storage area includes a virtual read-only partition and a storage partition. The virtual read-only partition may be a partition emulating a CD-ROM and thus appearing as a CD-ROM drive to the operating system of a computer connected with the removable storage device. The content of the CD-ROM partition may be preconfigured during the manufacture of the removable storage device. The CD-ROM partition not only provides a read-only partition for storing critical software components, but it also provides the computer with an auto-run feature, which allows the components stored in the CD-ROM partition to launch on the computer automatically. On the other hand, the storage partition is computer writeable and is configured to store data. It is worth nothing that the storage area may include more than one storage partition.

In one implementation, the controller is configured to gather a first set of information associated with the entire removable storage device, including information associated with the virtual read-only partition and also with the storage partition. In addition, the controller is configured to process the first set of information by masking a certain portion of the first set of information to generate a second set of information associated with the removable storage device. For example, the second set of information may refer to the information associated with the virtual read-only partition only.

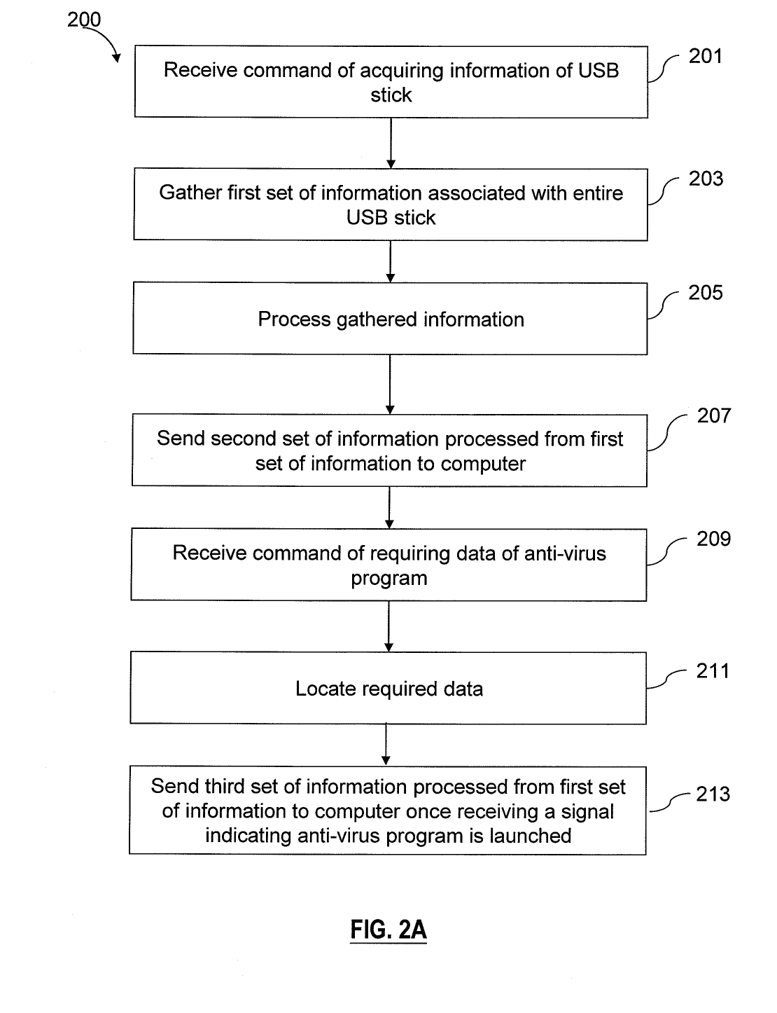

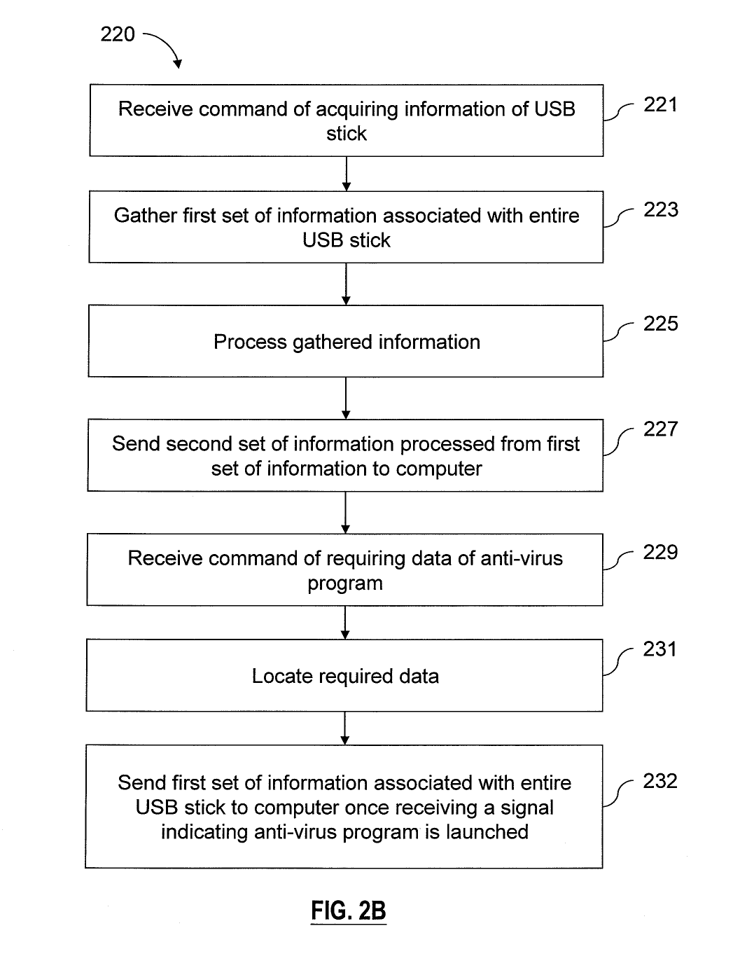

FIG. 2A is a flow chart 200 illustrating the method step of a USB stick configured to prevent virus infection as it comes into contact with a computer, according to one embodiment of the invention. Initially, the controller receives a command of acquiring information of the USB stick from the computer in step 201. In one implementation, the command is represented by a hardware-generated signal. The assertion of the hardware-generated signal may be caused by of the insertion of the USB stick to the computer or a reset event resulting from an internal mistake of the computer. In another implementation, the command is represented by a data unit that is generated in response to the occurrences of certain events, such as, without limitation, a forced shutting down of an antivirus program initially launched on the computer or a reset event triggered by a watchdog timer after the computer fails to respond after a certain period of time.

After receiving the command, the controller gathers the first set of information associated with the entire USB stick in step 203. This gathered information includes information associated with a virtual read-only partition and a storage partition of the USB stick, such as, without limitation, specific volumes of the two partitions and data content on each sector of the two partitions. The controller then processes the gathered information in step 205. Specifically, a portion of the gathered information is masked to generate a second set of information, which no longer includes the information associated with the storage partition but only the information associated with the virtual read-only partition and a third set of information, which no longer includes the information associated with the virtual read-only partition but only the information associated with the storage partition.

In step 207, the controller sends the second set of information to the computer. Because the computer receives information associated only with the virtual read-only partition, the computer at this stage identifies the USB stick as a read-only device. In one implementation, this read-only device may also appear as a CD-ROM drive to the computer.

It is worth noting again that one way a virus (e.g., auto-run virus) spreads via the use of a USB stick is the automatic copying of itself to the USB stick as the USB stick is plugged into an infected computer. Here, by making the USB stick appear as a read-only device to the computer, the chance of writing the virus to this USB stick and thus infecting the USB stick decreases.

After the USB stick is identified as a read-only device, the controller receives a command of reading data for an antivirus program stored in the virtual read-only partition of the USB stick in step 209. In one implementation, the command is a data unit containing certain characteristic information, such as CommandType. The characteristic information allows the controller of the USB stick to recognize such a request is a read request. In one implementation, the computer sends multiple commands intermittently to access the virtual read-only partition.

After receiving the read command, the controller starts to identify the physical locations of the sectors that store the antivirus program in step 211. Because the computer identifies the USB stick as a read-only device, for example, a 640 MB CD-ROM drive, the command from the computer is also to access a sector based on the local coordinate system for the 640 MB virtual CD-ROM drive. However, in order to identify the physical location of this specific sector based on the global coordinate system for the entire storage area, including both the virtual CD-ROM and the storage partition, the controller utilizes the first set of information gathered in step 203 to map the local coordinates associated with the sector to the global coordinates associated with the sector. Remapping and/or capturing techniques may be used in this step 211. Once the physical location that stores the requested data is identified, the controller accesses the data requested by the computer and sends the data back to the computer. In one implementation, the controller sends data units containing an antivirus program. After the computer launches the antivirus program, the controller receives a signal indicative of the antivirus program being launched on the computer.

After receiving such a signal, the controller sends the third set of information to the computer in step 213. As discussed above, the third set of information is generated from the first set of information associated with the entire USB stick by masking a portion of the first set of information. In one implementation, the third set of information excludes the information associated with the virtual read-only partition and only includes the information associated with the storage partition. After receiving information associated only with only the storage partition, the computer identifies the USB stick as a writable device and the storage partition as a writable drive in the system.

After the storage partition is recognized to be writable, requests to access the storage partition begin to occur. The controller then initiates a neuro-fuzzy analysis engine and a signature analysis engine to analyze and monitor how this writable storage partition is accessed. If any abnormal access behavior is detected, the controller notifies the antivirus program, which may perform an action (e.g., report the anomaly) to counter such an access.

FIG. 2B is a flow chart 220 illustrating the method step of a USB stick configured to prevent virus infection as it comes into contact with a computer, according to another embodiment of the invention. The steps 221, 223, 227, 229, and 231 of FIG. 2B are the same with the steps 201, 203, 207, 209, and 211, respectively, described above and illustrated in FIG. 2A. However, unlike step 205, in FIG. 2B, the controller processes the information gathered in step 223 to generate a second set of information but not a third set of information in step 225. Here, the second set of information no longer includes the information associated with the storage partition but only the information associated with the virtual read-only partition.

In step 232, the controller sends the first set of information, the information associated with the entire USB stick, to the computer. As a result, the computer at this stage identifies the USB stick to be both a read-only and a writable device. Specifically, the virtual read-only partition and the storage partition are recognized as a read-only drive and a writable drive in the computer, respectively.

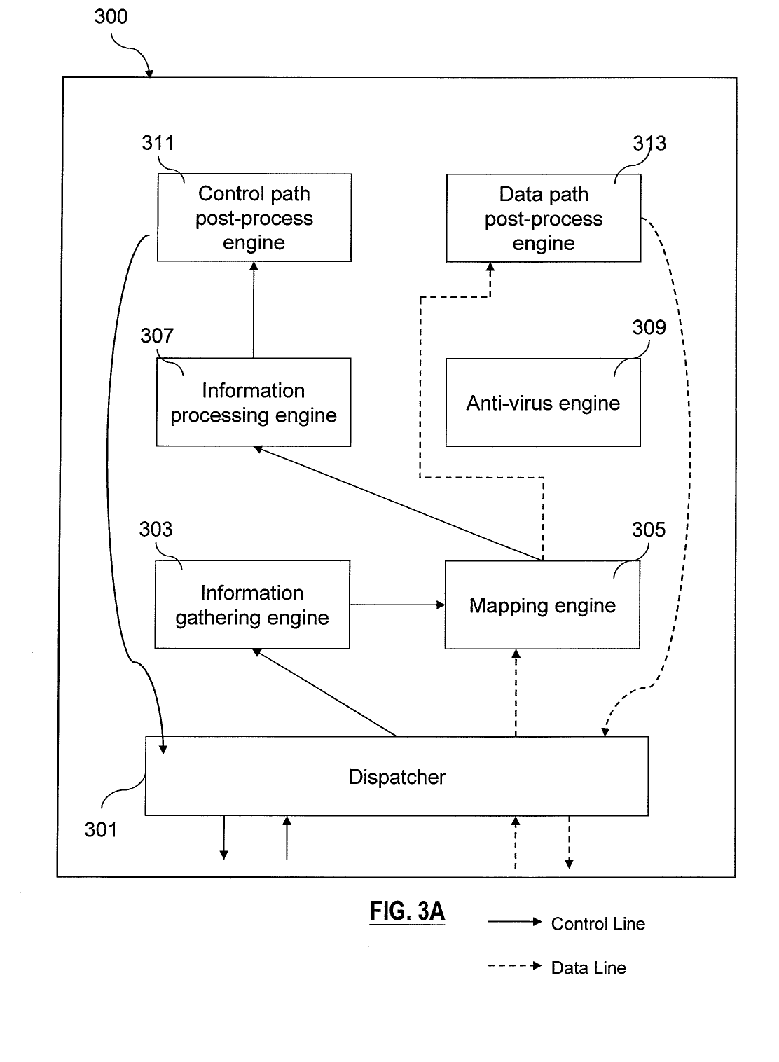

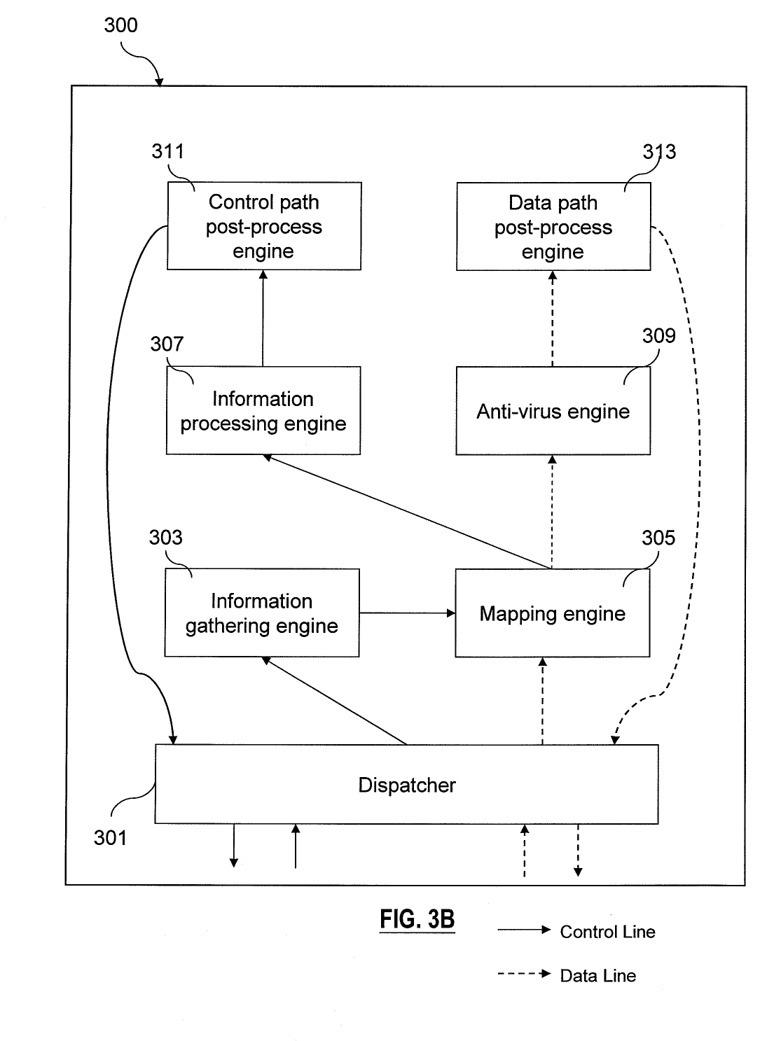

In one embodiment of the invention, the method steps set forth above can be carried out by a chip embedded in a controller of a removable storage device. The chip includes a dispatcher, an information gathering engine, a mapping engine, an information processing engine, an antivirus engine, a control path post-process engine, and a data path post-process engine. FIG. 3A is a conceptual diagram of a chip 300 illustrating certain control signal flow and data signal flow that cause a computer connected to a USB stick to identify the USB stick as a read-only device, according to one embodiment of the invention. As discussed above, the USB stick includes a virtual read-only partition and a writable storage partition. The paths for the control signals are shown in solid lines, and the paths for the data signals are shown in dotted lines. After the USB stick is inserted to a computer, the computer sends a command requesting for information of the USB stick. The request is received by a dispatcher 301. The dispatcher 301 is capable of distinguishing between a command associated with control data and a command associated with payload data. Because the command of requesting for USB stick information is considered to be control related data, the dispatcher 301 sends such a command to the information gathering engine 303. In response, the information gathering engine 303 gathers a first set of information associated with the entire USB stick, including the information associated with both the virtual read-only partition and the writable storage partition. The gathered information is then sent to the mapping engine 305. The mapping engine 305 temporarily stores the gathered information. The gathered information is further processed by the information processing engine 307 to mask a portion of the gathered information and generate a second set of information only associated with the virtual read-only partition of the USB stick. The control path post-process engine 311 then sends this newly generated second set of information to the computer through the dispatcher 301.

Because the computer only has the information associated with the virtual read-only partition of the USB stick, the computer identifies the USB stick as a read-only device, such as a CD-ROM drive. The computer then sends a read command to the USB stick requesting to read certain data stored on the specific sectors of the read-only device. The dispatcher 301 recognizes this read command to be associated with payload data and sends it to the mapping engine 305 to locate the physical locations for the requested data. As discussed above, in one implementation, the requested data is associated with an antivirus program. The mapping engine 305 utilizes the gathered information previously stored to determine the physical locations of the specific sectors based on the global coordinate system for the entire storage area, including the virtual read-only partition and the writable storage partition, of the USB stick. The data path post-process engine 313 then accesses the determined physical locations and sends the requested data to the computer through the dispatcher 301. In one embodiment of the invention, an antivirus program is automatically launched on the computer after the computer receives the requested data associated with the antivirus program stored in the virtual read-only partition of the USB stick.

FIG. 3B is another conceptual diagram of the chip 300 illustrating certain control signal flow and data signal flow after the antivirus program is launched on the computer, according to one embodiment of the invention. Similar to FIG. 3A, the paths for the control signals are shown in solid lines, and paths for the data signals are shown in dotted lines. After the antivirus program is launched on the computer, the dispatcher 301 receives a control signal indicative of the launch of the antivirus program. This control signal reaches the information processing engine 307 via the information gathering engine 303, the mapping engine 305, and the antivirus engine 309. After the information processing engine 307 receives the control signal, the information processing engine 307 further processes the first set of information gathered from the information gathering engine 303 and generates a third set of information only associated with the storage partition of the USB stick. The control path post-process engine 311 then sends this newly generated third set of information to the computer through the dispatcher 301. Because the computer only has the information associated with the storage partition of the USB stick, the computer identifies the USB stick as a writable device, such as a hard drive.

In an alternative implementation, after the information processing engine 307 receives the control signal indicative of the launch of the antivirus program. The information processing engine 307 is disabled and thus sends the first set of information associated with the entire USB stick, including the information associated with both the virtual read-only partition and the writable storage partition, to the computer. With the gathered first set of information, the computer is able to recognize the existence of the writable storage partition as well as the virtual read-only partition.

The requests issued by the computer to access the writable storage partition can be read or write requests and are considered to be associated with payload data. Such a request, also referred to as the data signal, is directed to the mapping engine 305 for identifying the physical locations of the specific sectors in the writable storage partition. The antivirus engine 309 monitors the access behaviors and reports any anomaly to the antivirus program on the computer. In one implementation, the antivirus engine 309 also includes a neuro-fuzzy analysis engine and a signature analysis engine. The data path post-process engine 313 accesses the writable storage partition and communicates with the computer through the dispatcher 301. It should be noted that FIGS. 3A and 3B only illustrate one implementation of the chip. For instance, each of the aforementioned engines may combine with another, some, or all of the other engines to perform the same functions as described above.

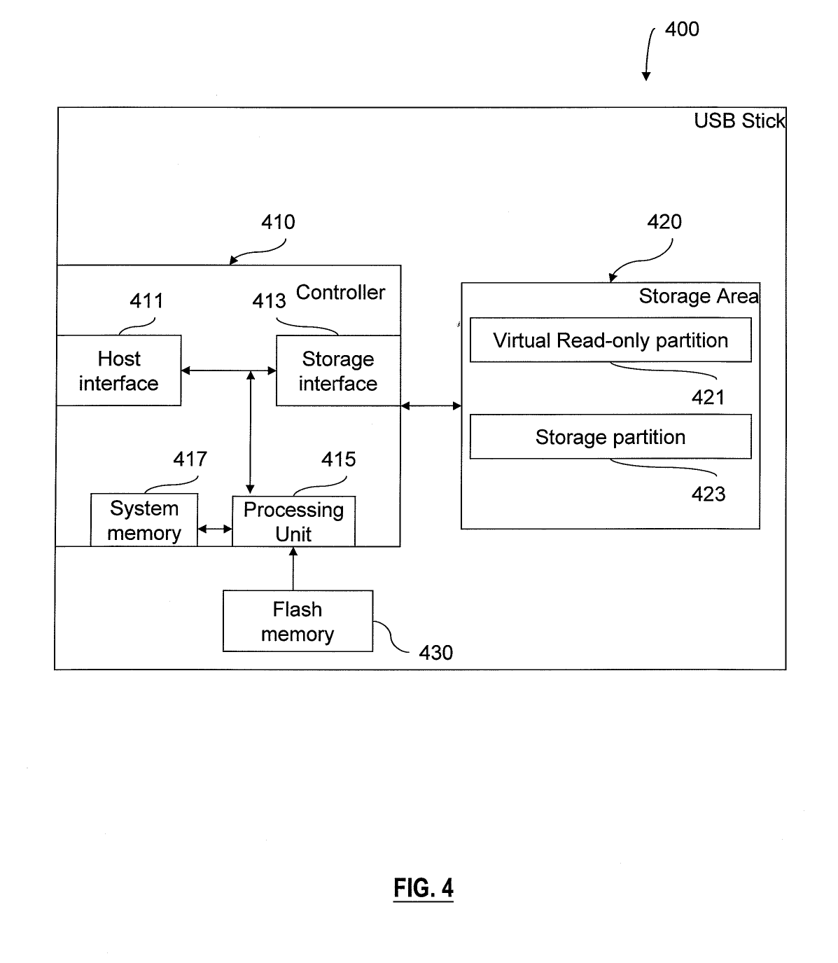

FIG. 4 is a conceptual diagram of a USB stick configured to implement one or more aspects of the present invention. The USB stick 400 includes a computing device 410, a host interface 411, a storage area 420, and a flash memory 430. The USB stick 400 communicates with a computer through the host interface 411. The computing device 410 is configured to control the communication between the storage area 420 and the computer.

In one implementation, the computing device 410 is the controller as described above. In addition to the host interface 411, the computing device 410 also includes a storage interface 413, a processing unit 415, and a system memory 417. The processing unit 415 connects to the system memory 417 and the flash memory 430. In addition, the processing unit 415 loads programming instructions stored in the flash memory 430 into the system memory 417, executes the programming instructions from the system memory 417, and communicates with the storage area 420 through the storage interface 413 and with the computer through the host interface 411. Alternatively, the processing unit 415, the host interface 411, and the storage interface 413 may be integrated into a single processing unit. The flash memory 430 may be embedded in the computing device 410. The system memory 417 may typically include dynamic random access memory (DRAM) configured to either connect directly to the processing unit 415 (as shown) or connect indirectly to the processing unit 415 via a system interface.

The storage area includes a virtual read-only partition 421 and at least one storage partition 423. In one implementation, the virtual read-only partition 421 stores an antivirus program. The storage partition 423 is a readable/writeable partition and is configured to store data.

After the computing device 410 receives a command of acquiring the information of the USB stick 400 through the host interface 411 from a computer, the processing unit 415 executes programming instructions stored in the system memory 417. The programming instructions generally are stored in the flash memory 430 and are loaded into the system memory 417 by the processing unit 415 after the computing device 410 is powered on. The processing unit 415 then communicates with the storage area 420 to gather information associated with the virtual read-only partition 421 and the information associated with the storage partition 423 and process the gathered information to generate information that is associated with the virtual read-only partition 421 but is not associated with the storage partition 423. The processing unit 415 reports this generated information to the computer and causes the computer to identify the USB stick 400 as a read-only device.

Suppose the computer identifies the USB stick as a 640 MB CD-ROM. Any requests issued by the computer to access data are based on the local coordinate system for the 640 MB virtual CD-ROM. In order to identify the physical location of a specific sector under the global coordinate system for the entire storage area including both the virtual read-only partition 421 and the storage partition 423, the processing unit 415 maps the local coordinates to the global coordinates of the specific sector. The processing unit 415 further communicates with the virtual read-only partition 421, accesses the antivirus program, and sends the data units associated with the antivirus program to the computer.

After the antivirus program is launched on the computer, the computing device 410 receives a signal from the computer indicative of the antivirus program being launched on the computer. The processing unit 415 then processes the gathered information associated with the virtual read-only partition 421 and the information associated with the storage partition 423 to generate the information that is associated with the storage partition 423 but is not associated with the virtual read-only partition 421. The processing unit 415 causes this generated information to be sent to the computer and causes the computer to identify the USB stick 400 as a writable device. Alternatively, the processing unit 415 sends the gathered information associated with the entire USB stick 400, including both the information associated with the virtual read-only partition 421 and the information associated with the storage partition 423, to the computer and causes the computer to identify the USB stick 400 as both a read-only and a writable device. Then, the processing unit 415 initiates a neuro-fuzzy analysis engine and a signature analysis engine in the system memory 417 to analyze and monitor access behaviors to the storage area 420 of the USB stick 400. If any abnormal access behavior is detected, the computing device 410 notifies the antivirus program on the computer, which, as discussed above, may perform an action in response to such an access.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, DVD disks readable by a DVD driver, ROM chips or any type of solid-state non-volatile semiconductor memory) on which information is permanently stored; and (ii) writable storage media (e.g., floppy disks within a diskette drive, hard-disk drive, CD-RW, DVD-RW, solid-state drive, flash memory, or any type of random-access memory) on which alterable information is stored. Such computer-readable storage media, when carrying computer-readable instructions that direct the functions of the present invention, are embodiments of the present invention. Therefore, the above examples, embodiments, and drawings should not be deemed to be the only embodiments, and are presented to illustrate the flexibility and advantages of the present invention as defined by the following claims.

We claim:

1. A method for preventing virus infections via the use of a removable storage device configured to connect to a computer, comprising:
gathering a first set of information associated with the removable storage device;
processing the first set of information to generate a second set of information also associated with the removable storage device;
sending the second set of information to the computer to cause the computer to identify the removable storage device as a read-only device;
accessing an antivirus program stored in the removable storage device and causing the antivirus program to be launched on the computer; and
sending a third set of information to the computer to cause the computer to identify the removable storage device as a writable device after the antivirus program is launched on the computer.

2. The method of claim 1, further comprising initiating the gathering step in response to a command requesting to identify the removable storage device.

3. The method of claim 1, wherein the first set of information comprises information associated with a virtual read-only partition and information associated with a storage partition, wherein both the virtual read-only partition and the storage partition belong to a storage area in the removable storage device.

4. The method of claim 1, wherein the second set of information includes information associated with a virtual read-only partition in the removable storage device but excludes information associated with a storage partition in the removable storage device.

5. The method of claim 1, wherein the third set of information includes information associated with a storage partition in the removable storage device but excludes information associated with a virtual read-only partition in the removable storage device.

6. The method of claim 3, wherein the third set of information is the first set of information.

7. The method of claim 1, further comprising initiating the accessing step in response to a command requesting to access the antivirus program.

8. A computer-readable medium containing a sequence of instructions, which when executed by a computing device in a removable storage device, causes the computing device to:
gather a first set of information associated with the removable storage device;
process the first set of information to generate a second set of information also associated with the removable storage device;
send the second set of information to a computer coupled to the removable storage device to cause the computer to identify the removable storage device as a read-only device;
access an antivirus program stored in the removable storage device and cause the antivirus program to be launched on the computer; and
send a third set of information to the computer to cause the computer to identify the removable storage device as a writable device after the antivirus program is launched on the computer.

9. The computer-readable medium of claim 8, further containing a sequence of instructions, which when executed by the computing device, causes the computing device to gather the first set of information in response to receiving a command requesting for information to identify the removable storage device.

10. The computer-readable medium of claim 8, further containing a sequence of instructions, which when executed by the computing device, causes the computing device to gather the first set of information comprising information associated with a virtual read-only partition and information associated with a storage partition, wherein both the virtual read-only partition and the storage partition belong to a storage area in the removable storage device.

11. The computer-readable medium of claim 8, wherein the second set of information includes information associated with a virtual read-only partition in the removable storage device but excludes information associated with a storage partition also in the removable storage device.

12. The computer-readable medium of claim 8, wherein the third set of information includes information associated with a storage partition in the removable storage device but excludes information associated with a virtual read-only partition in the removable storage device.

13. The computer-readable medium of claim 10, wherein the third set of information is the first set of information.

14. The computer-readable medium of claim 8, further containing a sequence of instructions, which when executed by the computing device, causes the computing device to access the antivirus program in response to a command requesting to access the antivirus program.

15. A removable storage device, comprising:
a storage area including a virtual read-only partition and a storage partition; and
a computing device, coupled to the storage area, further including a system memory, and a processing unit, wherein the processing unit is configured to
gather a first set of information associated with the removable storage device,
process the first set of information to generate a second set of information also associated with the removable storage device,
send the second set of information to a computer coupled to the removable storage device to cause the computer to identify the removable storage device as a read-only device,
access an antivirus program stored in the removable storage device and cause the antivirus program to be launched on the computer, and
send a third set of information to the computer to cause the computer to identify the removable storage device as a writable device after the antivirus program is launched on the computer.

16. The removable storage device of claim 15, wherein the processing unit is further configured to gather the first set of information in response to receiving a command requesting for information to identify the removable storage device.

17. The removable storage device of claim 15, wherein the second set of information includes information associated with the virtual read-only partition but excludes information associated with the storage partition.

18. The removable storage device of claim 15, wherein the third set of information includes information associated with the storage partition but excludes information associated with the virtual read-only partition.

19. The removable storage device of claim 15, wherein the third set of information is the first set of information.

20. The removable storage device of claim 15, wherein the processing unit is further configured to access the antivirus program in response to receiving a command requesting to access the antivirus program.
